(19) United States
(12) Patent Application Publication
(10) Pub. No.: US 2026/0125514 A1
(43) Pub. Date: May 7, 2026

(54) CROSSLINKED POLYMERS AND THEIR USES

(71) Applicants: UNIVERSITÉ CÔTE D'AZUR, Nice (FR); CENTRE NATIONAL DE LA RECHERCHE SCIENTIFIQUE, Paris (FR); UNIVERSITÉ CLAUDE BERNARD LYON 1, Villeurbanne (FR)

(72) Inventors: Nathanaël GUIGO, La Gaude (FR); Mohamed MEHIRI, Nice (FR); Giuseppe MELILLI, Annecy (FR); Patricia ROUSSELLE, Lyon (FR); Nicolas SBIRRAZZUOLI, Beaulieu-sur-Mer (FR)

(73) Assignees: UNIVERSITÉ CÔTE D'AZUR, Nice (FR); CENTRE NATIONAL DE LA RECHERCHE SCIENTIFIQUE, Paris (FR); UNIVERSITÉ CLAUDE BERNARD LYON 1, Villeurbanne (FR)

(21) Appl. No.: 19/120,399

(22) PCT Filed: Nov. 3, 2023
(86) PCT No.: PCT/EP2023/080692

§ 371 Date: Apr. 11, 2025

(30) Foreign Application Priority Data
Nov. 3, 2022 (EP) 22306657.2

(51) Int. Cl. C08H 1/06; C08J 3/24

(52) U.S. Cl. CPC C08H 1/06; C08J 3/24; C08J 2389/06

(57) ABSTRACT

A composition including homogenous mixture of a polymer containing at least two free amino functional groups, and a compound having an aldehyde functional group, the compound being of formula (I) or formula (II)

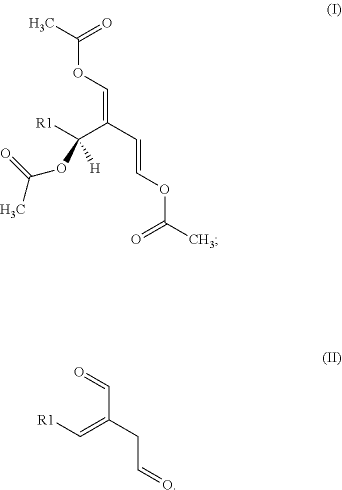

R1 is C5-C25 alkyl, having one or more double bonds, and/or one or more triple bonds, possibly branched. The stoichiometric ratio between the aldehyde functional group contained in the compound and the amino functional groups contained in the polymer is from 0.1 to 3.

### FIELD

The invention relates to crosslinked polymers, and their uses in particular in therapy and treatments of human and animal body.

### BACKGROUND

Tissue engineering involves the use of materials with suitable biochemical and physiological properties to replace, repair, regenerate biological tissues and/or enhance these processes. The particular tissue involved may have certain mechanical and structural requirements for proper functioning. There is a need for materials which are easily tunable for use with a particular target tissue and have suitable biochemical and physiological properties for tissue engineering.

Polymer hydrogels have structural similarities to numerous macromolecular components in the human body, are generally considered biocompatible, and have been investigated extensively as materials useful for drug delivery, tissue repair and tissue engineering, as well as for use as surgical sealants and adhesives. With increasing frequency, polymer hydrogels are designed for in situ gelation from a liquid precursor, thereby allowing minimally invasive administration via syringe or needle.

Existing hydrogel systems, formed chemically or physically, are subject to several limitations. Chemically cross-linked hydrogels often employ toxic cross-linking agents and/or radicals, and the resulting hydrogels are often non-biodegradable. On the other hand, physical hydrogels—formed through ionic interactions, hydrophobic interactions, hydrogen bonding, or phase transition-—are relatively weak and can be prone to unwanted or uncontrollable degradation through ion exchange, ion diffusion, or monomer dissolution. An alternate approach—solidification by enzymatic cross-linking-—has two principal advantages, compared to other hydrogel systems. First, an enzyme has substrate specificity to allow controllable gel formation. Second, an enzymatic method can be applied to the in vivo utilization of cross-linked hydrogels, under appropriate physiological conditions.

A particular biopolymer for use in medical applications is disclosed in U.S. Pat. No. 6,132,759, which relates to a medicament containing a biopolymer matrix comprising gelatin cross-linked with oxidized polysaccharides. The biopolymer of this patent is claimed to be useful for treating skin wounds or dermatological disorders.

However, use of non-natural crosslinker is not required.

Biomass and biomass-derived products have attracted a lot of attention as potential precursors for a wide variety of bio-based materials, but also for the appeal of natural platform molecules that can also offer a great combination of strategies to design innovative bioinspired functional materials. Among the different algal bioresources, some of them-mainly macroalgae—are still under-exploited while they can be highly invasive, which can lead to ecological problems.

Therefore, there is a need to provide new bio-based materials, useful for animal and human application, avoiding chemistry based-compound.

### SUMMARY

One aim of the invention is to provide a new and easy process to produce bio-based gel, that is biocompatible for animal and human application.

Other aim of the invention is to provide medical and non-medical application of this gel.

Still another aim of the invention is to provide a process for producing such a gel.

Thus, the invention relates to a composition, preferably isolated, comprising, comprising essentially, or consisting of a homogenous mixture of:
a polymer containing at least two free amino functional groups, and
a compound comprising an aldehyde functional group, said compound being of formula I

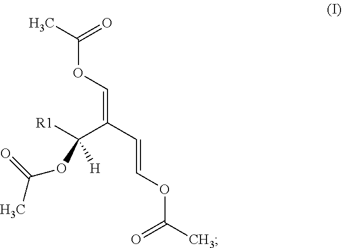

or of formula II,

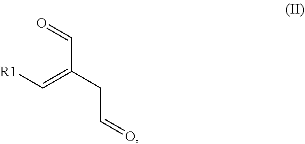

wherein R1 is C5-C25 alkyl, having one or more double bonds, and/or one or more triple bonds, possibly branched,
wherein the stoichiometric ratio between the aldehyde functional group contained in the compound and the amino functional groups contained in the polymer is from 0.1 to 3.

### BRIEF DESCRIPTION OF THE DRAWINGS

The invention will be better understood in view of the following drawings and examples

FIG. 1 represent photos of crosslinked gelatin hydrogels obtained with a concentration of 5 wt % (A), 10 wt % (B) or 15 wt % (C) Caulerpenyne (CYN).

FIG. 2 represents microscopic photos of (A) un-crosslinked gelatin, and (B and C) gelatin crosslinked with 5 or 10% Caulerpenyne, respectively. Neat gelatin was processed in the same way without adding CYN. The hydrogel so obtained was referred to uncrosslinked gelatin.

FIG. 3 represents a graph showing the hydrolysis rate (in %) over the time in months, of networks crosslinked with 5 wt % (square), 10 wt % (circle) and 15 wt % (triangle) caulerpenyne (CYN).

FIG. 4 represents a graph showing the sweeling degree (%) of networks crosslinked with 5% (A), 10% (B) and 15% (C) caulerpenyne (CYN).

FIG. 5 is a graph showing fibroblast growth (OD at 590 nm) over the time (in hours) when seeded on plates coated with gelatin (A) or reticulated gelatin with 5 wt % (α-curve with square), 10 wt % (C-curve with triangles) or 15 wt % caulerpenyne.

FIG. 6 represents photographies of human dermal fibroblast seeded on dished under the following conditions:
A: photo of cells after 1h on a dish covered with gelatin reticulated with 5 wt % caulerpenyne,
B: photo of cells after 48h on a dish covered with gelatin reticulated with 5 wt % caulerpenyne,
C: photo of cells after 1h on a dish covered with gelatin reticulated with 10 wt % caulerpenyne,
D: photo of cells after 48h on a dish covered with gelatin reticulated with 10 wt % caulerpenyne,
E: photo of cells after 1h on a dish covered with gelatin reticulated with 15 wt % caulerpenyne,
F: photo of cells after 48h on a dish covered with gelatin reticulated with 15 wt % caulerpenyne,
G: photo of cells after 1h on a dish covered with gelatin, and
H: photo of cells after 48h on a dish covered with gelatin.

FIG. 7 is a graph showing fibroblast adhesion to gels (% of total cells seeded), the gels being A: gelatin, B: gelatin reticulated with 5 wt % caulerpenyne, C: gelatin reticulated with 10 wt % caulerpenyne, D: gelatin reticulated with 15 wt % caulerpenyne.

FIG. 8 is a graph showing human epidermal keratinocytes growth (OD at 590 nm) over the time (in hours) when seeded on plates coated with gelatin (A) or reticulated gelatin with 5 wt % (B), 10 wt % (C) or 15 wt % (D) caulerpenyne.

FIG. 9 represents photographies of human epidermal keratinocytes seeded on dished under the following conditions:
A: photo of cells after 2h on a dish covered with gelatin reticulated with 5 wt % caulerpenyne,
B: photo of cells after 24h on a dish covered with gelatin reticulated with 5 wt % caulerpenyne,
C: photo of cells after 2h on a dish covered with gelatin reticulated with 10 wt % caulerpenyne,
D: photo of cells after 24h on a dish covered with gelatin reticulated with 10 wt % caulerpenyne,
E: photo of cells after 2h on a dish covered with gelatin reticulated with 15 wt % caulerpenyne,
F: photo of cells after 24h on a dish covered with gelatin reticulated with 15 wt % caulerpenyne,
G: photo of cells after 2h on a dish covered with gelatin, and
H: photo of cells after 24h on a dish covered with gelatin.

FIG. 10 is a graph showing human epidermal keratinocytes adhesion to gels (% of total cells seeded), the gels being A: gelatin, B: gelatin reticulated with 5 wt % caulerpenyne, C: gelatin reticulated with 10 wt % caulerpenyne, D: gelatin reticulated with 15 wt % caulerpenyne.

FIG. 11 shows images of full thickness punch wounds on the back of two pigs at JO (A and B) and immediate treatment with a gelatin hydrogel cross-linked to 5% with caulerpeunyne (C) or genipin (D) as indicated. Appearance of the two healed skin wounds on day 10 after injury is shown: E: with a gelatin hydrogel cross-linked to 5% with caulerpeunyne and F: with a gelatin hydrogel cross-linked to 5% with genipin. Bar 5 mm.

FIG. 12 represents HES-stained histological sections of the above-described whole wound biopsies shown in Figure No 11 treated with hydrogel cross-linked with caulerpeunyne (A.; B.) or genipin (C.; D.) and taken on day 7 (A.; C.) and 10 (B.; D.) after injury as indicated. GT granulation tissue; mGT, mature granulation tissue; E, epidermis; cE, complete epidermisation; rE, regenerated epidermis. Bar 1 mm.

### DETAILED DESCRIPTION

The invention is based on the unexpected observation made by the inventors that a composition comprising a polymer having free amino functional groups and the compound of formula I or II, can form, further to crosslinking, reaction a new and useful crosslinked polymer that can be used for many applications, and in particular for medical applications.

Due to the reaction between free amino functional groups and aldehyde functional groups, a Paal-Knorr reaction is carried out, creating a covalent bond between the polymer and the compound of formula I or II.

The reaction, because the polymer contains at least two free amino functional groups, will produce a crosslinked network, on the contrary to a reaction involving a polymer having only one free amino functional group, which lead to crosslinked fiber or linear polymer.

In the invention, “free amino functional groups” means a primary, a secondary or a tertiary amine, preferably primary amine, which is available to react with an aldehyde. This free amino functional group is therefore exposed at the periphery of the polymer, for instance as the final functional group of a ramified group of a polymer.

In the invention, “an aldehyde functional group” means an aldehyde group of formula-CHO or—CH═O, called free aldehyde, or a solvate or a ionic form thereof, or any protected aldehyde group wherein oxygen atom is protected by acetalization, or other kind of protection such as: dithiane, hemiacetal, or acetal.

The aldehyde functional group according to the invention, in its protected form, can be obtained directly from plan or animal (i.e. the protection occurs naturally), or protected by a chemical reaction carried out in a laboratory.

In the invention, a composition “consisting essentially of” or “consist essentially of” a first and a second compounds means that the composition contains the first and the second compounds, and possibly additional ingredients, but solely the first and the second compounds participate to the technical effect of the composition.

Compounds of formula I and II can be considered, within the context of the invention, as crosslinking agents. They are involved in the resulting crosslinked network and are not considered as a catalyst of the reaction.

Both compounds of formula I and II have a residue R1 which is a C5-C25 alkyl, which means that R1 is a C5, C6, C7, C8, C9, C10, C11, C12, C13, C14, C15, C16, C17, C18, C19, C20, C21, C22, C23, C24 or C25 alkyl comprising one or more double bond and/or one or more triple bond.

Examples of R1 residue according to the invention are advantageously C5-C9 alkyls as defined above, and more preferably the following residues:

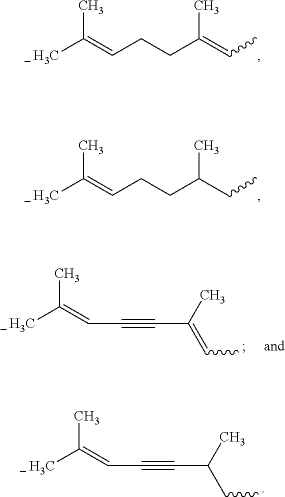

Compounds of formula I and II harbor at least 2 aldehyde functional groups, each of these at least 2 aldehyde functional groups being able to react, as defined above, with a free amino functional group. Within the context of the invention, aldehyde means a —CO—H group, i.e. an aldehyde per se, but also an acetaldehyde group of formula —CO—CH₃.

Advantageous compounds of formula I are the following ones:

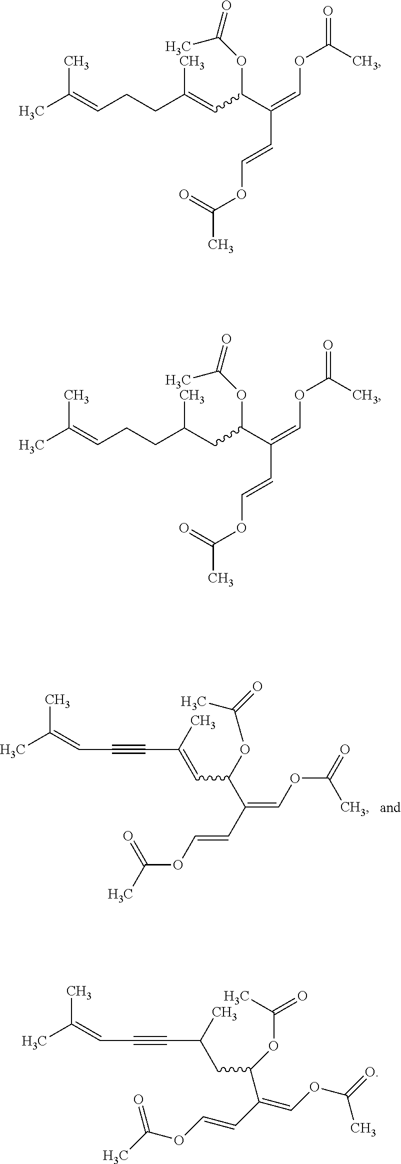 [SMILES: CC(=O)O/C=C(/C=C/OC(C)=O)C(C=C(C)CCC=C(C)C)OC(C)=O ; CC(=O)O/C=C(/C=C/OC(C)=O)C(CC(C)CCC=C(C)C)OC(C)=O ; CC(=O)O/C=C(/C=C/OC(C)=O)C(C=C(C)C#CC=C(C)C)OC(C)=O ; "and" ; CC(=O)O/C=C(/C=C/OC(C)=O)C(CC(C)C#CC=C(C)C)OC(C)=O]

Advantageous compounds of formula II are the following ones:

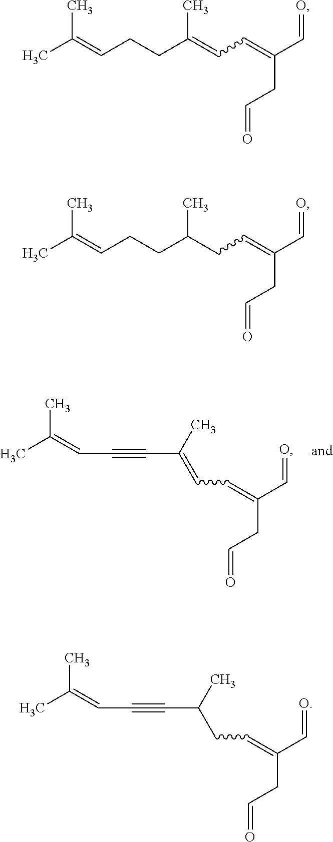 [SMILES: CC(C)=CCCC(C)=CC=C(C=O)CC=O ; CC(C)=CCCC(C)CC=C(C=O)CC=O ; CC(C)=CC#CC(C)=CC=C(C=O)CC=O ; CC(C)=CC#CC(C)CC=C(C=O)CC=O]

The composition according to the invention, the polymer and the compounds I or II are chosen such that the stoichiometric ratio between the aldehyde functional groups contained in the compound and the amino functional groups contained in the polymer is from 0.1 to 3. This means that the nature and/or the amount of the polymer will determine the amount of compound I or II in the composition.

A stoichiometric ratio shows the relationship between the molecules present in an equation. These proportion convey the necessary quantities of certain chemical functional groups with the intent to trigger the chemical reactions. When the ratio of the aldehyde functional groups contained in the compound and the amino functional groups contained in the polymer equals to 0.1, this means that the composition comprises 1 mole of aldehyde functional groups contained in the compound and 10 moles of the amino functional groups contained in the polymer. Moreover, when the ratio of the aldehyde functional groups contained in the compound and the amino functional groups contained in the polymer equals to 3, this means that the composition comprises 3 moles of aldehyde functional groups contained in the compound and 1 mole of the amino functional groups contained in the polymer.

In the invention, a stoichiometric ratio varying from 0.1 to 3 means that the ratio can be, for example, equal to 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9 or 3. According to the above examples, the skilled person is able to determine the proportion of the aldehyde functional groups and the amino functional groups.

More advantageously, the invention relates to the composition as defined above, wherein the compound represents from 1 to 20%, preferably from 5 to 15% by weight of the composition.

In the invention, from 1 to 20% by weight, means 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5 or 20% by weight.

In the invention, from 5 to 15% by weight 5, 5.5, 6, 6.5, 7, 7.5, 8, 8.5, 9, 9.5, 10, 10.5, 11, 11.5, 12, 12.5, 13, 13.5, 14, 14.5 or 15% by weight.

The invention also relates to a structured network, preferably which is 3-dimentional, comprising or consisting essentially of a polymer containing at least two free amino functional groups operably crosslinked to compound comprising two aldehyde groups of formula II,

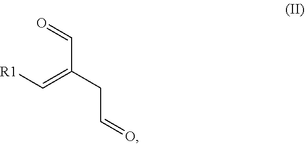

wherein R1 is as defined above, and
wherein the stoichiometric ratio between the aldehyde functional group contained in the compound and the amino functional groups contained in the polymer is from 0.1 to 3.

In another aspect the invention is based on the observation made by the inventors that the mixture of polymer containing at least two free amino functional groups with a compound of formula II produce a crosslinking reaction. A network is therefore obtained with specific features as described below.

The network obtained from the crosslinking reaction mentioned above is also called in the invention a scaffold.

The structured network according to the invention is either in a dry form or an hydrated form. This network, or scaffold, or matrix, is a tridimensional network wherein chains of polymers as defined above are connected to each other via compounds of formula II. This connection between the polymer and the compound of formula II is defined as an operably linkage and it corresponds to a covalent linkage between the molecules.

In other words, in the network according to the invention, polymer chains are covalently linked to molecules of compounds of formula II, in order to form a tridimensional structure.

As discussed earlier, the connection between the polymer and the compound II is carried out by a reaction between an aldehyde of compound and an amino group of the polymer. A majority of the bond created during the crosslinking reaction are intermolecular bonds, i.e. a compound of formula II connect to each other two different molecules of polymer. However, some intermolecular bonds can also be present in the network described herein, i.e. a compound of formula II connected to different amino functional group of the same unit of polymer.

Since the structure resulting of this crosslinking reaction is a network, the main bonds, i.e. the main covalent bonds, are intermolecular bonds.

Since the polymer and the compound of formula II are covalently linked, the structure is rigid, which means that only high molecular force (or high energy) can break the bonds between the polymer and the compound.

The network or scaffold described herein is therefore a structure containing interconnected open pores or interconnected voids, that could contain, or capture or absorb, a liquid, preferably an aqueous liquid. Advantageously, the pore size is in the range of 0.1 to 1000 μm, preferably of 0.1 to 500 μm. The pore number and size will depend upon the ratio between the aldehyde functional group contained in the compound and the amino functional groups contained in the polymer. If the ratio is close to 3, the pore number will be reduced compared to a network wherein the ratio is close to 0.1. Inversely, If the ratio is close to 3, the size of the pore will be larger compared to the network having a ratio close to 0.1.

As such, the network according to the invention is dried, and is only constituted of the polymer and the compound of formula 2. However, in presence of an aqueous liquid, said liquid will be able to occupy the voids or pores within the polymer such that the network becomes or remains wet. In other words, the voids or pores within the polymer are able to absorb said liquid to hydrate the network.

The network according to the invention is able to absorb more than 30 times its initial dry weight in aqueous liquid, in particular when the aqueous liquid is distilled water.

More advantageously, the invention relates to the structured network above mentioned, wherein the polymer containing at least two free amino functional groups is an animal or plant protein, a polysaccharide containing an amino group or an artificial amino polymer.

Advantageously, the polymer is a natural polymer originated from plant or animal, the polymer being chosen from amino polysaccharides such as chitosan, or amino modified polysaccharides, proteins containing amino acids such as lysine, arginine, histidine, ornithine, or peptides constituted by a repletion of one or more of these amino acids, such as poly-lysine peptides, poly-arginine, poly-ornithine, or poly histidine.

The polymer can also be an artificial, i.e. non naturally occurring polymer, Such as polyethylene glycol diamine and poly(vinyl) amine.

In the invention, if the polymer is originating from green algae, such as Caulerpa taxifolia algae, thus the compound of formula II involved in the crosslinking of the polymer—in order to produce the network defined above—is not Caulerpenyne (CYN) compound of formula IV

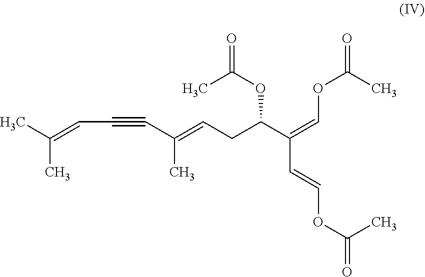 [SMILES: CC(=O)O/C=C(/C=C/OC(C)=O)[C@H](C/C=C(\C)C#CC=C(C)C)OC(C)=O]

or oxytoxine compound of formula III

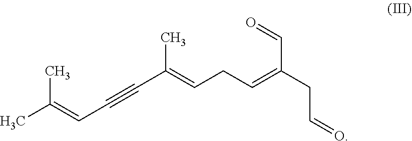 [SMILES: CC(C)=CC#C/C(C)=C/C/C=C(\C=O)CC=O]

More advantageously, the invention relates to the structured network as defined above, wherein the animal or plant protein is chosen from gelatin, keratin, casein and lactoserum proteins, elastin, collagen, soy protein, serum bovine albumin, fibrin and fibrinogen, and resilin.

Collagen is the main structural protein in the extracellular matrix found in the body's various connective tissues. As the main component of connective tissue, it is the most abundant protein in mammals. Collagen consists of amino acids bond together to form a triple helix of elongated fibril known as a collagen fibers.

Gelatin is a denatured product of collagen under acid, alkali, enzyme or high-temperature conditions. It is partially hydrolyzed to hold on to a lot of water causing gelling.

Keratin is one of a family of structural fibrous proteins also known as scleroproteins. Alpha-keratin (α-keratin) is a type of keratin found in vertebrates. Keratin monomers assemble into bundles to form intermediate filaments, which are tough and form strong unmineralized epidermal appendages found in reptiles, birds, amphibians, and mammals.

Casein is a family of related phosphoproteins (αS1, αS2,β, κ) that are commonly found in mammalian milk, comprising about 80% of the proteins in cow's milk.

Lactoserum, or whey is the liquid remaining after milk has been curdled and strained. Whey proteins consist of α-lactalbumin, β-lactoglobulin, serum albumin, immunoglobulins, and proteose peptones.

Bovine serum albumin corresponds to bovine serum “Fraction V”, i.e. the fifth fraction of the original Edwin Cohn purification methodology that made use of differential solubility characteristics of plasma proteins.

Elastin is a protein that is a key component of the extracellular matrix in gnathostomes (jawed vertebrates). Present in connective tissue, elastin allows many tissues to resume their shape after stretching or contracting.

Soy protein is a protein that is isolated from soybean. It is made from soybean meal that has been dehulled and defatted.

Fibrinogen (factor I) is a glycoprotein complex, produced in the liver, that circulates in the blood of all vertebrates. During tissue and vascular injury, it is converted enzymatically by thrombin to fibrin and then to a fibrin-based blood clot. The fibrinogen molecule circulates as a soluble plasma glycoprotein with a typical molecular weight of about 340-about 420 kDa

Fibrin (also called Factor Ia) is a fibrous, non-globular protein involved in the clotting of blood. It is formed by the action of the protease thrombin on fibrinogen, which causes it to polymerize.

Resilin is an elastomeric protein found in many insects and other arthropods. It provides soft rubber-elasticity to mechanically active organs and tissue

More advantageously, the polysaccharide containing an amino group is chosen from chitosan and, amino-hyaluronic acid, naturally aminated carbohydrates, but also mino-functionalized carbohydrates or sugar, such as amino-functionalized cellulose, amino-functionalized agarose, amino-functionalized alginate, amino-functionalized heparin and amino-functionalized chondroitin sulphate.

Chitosan is a linear polysaccharide composed of randomly distributed β-(1→4)-linked D-glucosamine (deacetylated unit) and N-acetyl-D-glucosamine (acetylated unit).

Hyaluronic acid, also called hyaluronan, is an anionic, nonsulfated glycosaminoglycan distributed widely throughout connective, epithelial, and neural tissues. Hyaluronic acid is constituted by a repetition β (1→4) of a dimer of D-Glucuronic acid and N-acetyl-D-glucosamine (1→3)).

More advantageously, an artificial amino polymer encompassed by the invention is chosen from polyethylene glycol diamine and poly(vinyl amine).

More advantageously, the invention relates to the structured network as defined above, the compound of formula II is oxytoxin-2 of formula III

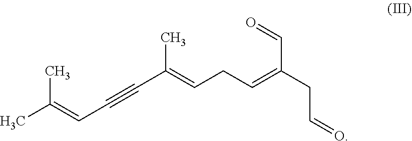 [SMILES: CC(C)=CC#C/C(C)=C/C/C=C(\C=O)CC=O]

In this advantageous embodiment, the network according to the invention will therefore be constituted by a polymer having free functional amino group, the animo group of said bolymer being linked to oxytoxin-2 via the aldehyde groups of said compound. If the free amino functional group of the polymer is a primary amine group, then an imine function (—N═CH—) will be the result of the crosslinking, i.e.
polymer-NH₂+O═CH-compound 2→Polymer-N═CH-compound 2+H₂O, as illustrated hereafter:

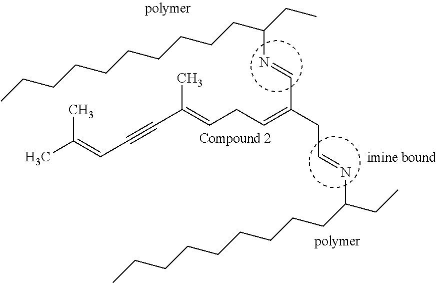 [SMILES: CCCCCCCCCCC(CC)/N=C/C(=C\C/C=C(\C)C#CC=C(C)C)C/C=N/C(CC)CCCCCCCCC]

Another mechanism is a crosslinking involving Paal-Knor reaction as illustrated hereafter

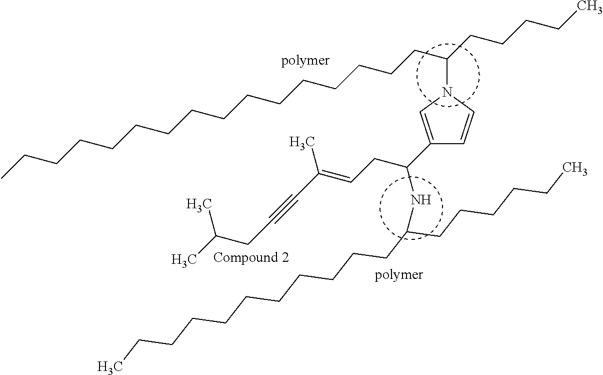

In the invention, reaction between free amino functional groups and aldehyde groups can be either intermolecular reactions, or intermolecular reactions (crosslinking compound reacts with many amino functional group within the same polymer).

Thus, the resulting network according to the invention may contain both types of intermolecular an intramolecular reaction.

The network according to the invention can also corresponds to a superposition of polymers that have reacted in an intramolecular manner with the crosslinking agent.

More advantageously, the invention relates to the structured network as defined above, wherein the polymer containing at least two free amino functional groups is chosen from gelatin and chitosan.

More advantageously, the invention relates to the structured network as defined above, wherein the polymer represents from 1 to 20% by weight, preferably from 5 to 15% by weight of the structured network.

Advantageously, the network according to the invention is constituted by oxytoxin-2 and gelatin, in particular wherein oxytoxin-2 represents from 1 to 20% by weight, preferably from 5 to 15% by weight of the structured network.

Advantageously, the network according to the invention is constituted by oxytoxin-2 and chitosan, in particular wherein oxytoxin-2 represents from 1 to 20% by weight, preferably from to 15% by weight of the structured network.

The invention also relates to the use of a composition as defined above, or a structured network as defined above, for lubricating a hydrophobic surface of a device, in particular a medical device.

In the invention, the network as defined above can be used in order to cover an hydrophobic surface of a medical device, in order to lubricate this surface.

Medical devices can be covered with a multitude of compositions or compounds depending on the intended uses. It may in particular be necessary to cover a medical device with a composition comprising a pharmaceutical agent or an agent allowing hydration, in particular in the context of implantation in an organism. Likewise, the use of a medical device can be improved by covering it with a lubricating composition, i.e. the network according to the invention, preferably in an hydrated form.

Therefore, in the invention, the “surface” or the “support” corresponds to a solid medical device, in particular that which is likely to cause friction while penetrating the human or animal body. For example, without being limiting, the support may be: the inside of a syringe, the plunger of a syringe, the rubber of the plunger of a syringe, a hollow needle, whether or not used with a syringe (whether it is acts on the outer surface of the needle or the channel thereof), a stent, a catheter (in particular for intracerebral, intracardiac, and vascular use as well as vascular guide wires), a lens (in particular a lens intended to be inserted into the eye), a probe, a drill, and more generally any medical or surgical instrument intended to allow the placement of an implant, a prosthesis suitable for being inserted into the human or animal body temporarily or permanently, a heart valve, a pacemaker, in particular an artificial pacemaker, an orthopedic implant, etc.

In the invention, the term “medical device” takes the legal meaning defined by French law, namely any instrument, device, equipment, material, product, or manufactured product, with the exception of products of human or animal origin, or any other article used alone or in combination, intended by the manufacturer for medical use in humans and the desired principal action of which is not obtained by pharmacological or immunological means or by metabolism, but the function of which may be assisted by such means.

The invention also relates to a structured network according as defined above, for its use for treating a human or an animal wound.

As is well-known in the prior art, usual methods for the cure of wounds whether in humans or animals, involve certain well-defined steps. These are curettage (removal of dead/infected tissues), disinfection (with disinfectants containing either iodine or hydrogen peroxide) and antibiotic therapy (either local or systemic, in form of powder, cream or spray). Lastly, to avoid hardening of the skin and crust formation, gauzes soaked in fatty humectants based on Vaseline, silicone oils or glycerol are applied. Dressing of the wound with sterile gauze is usually carried out not only to prevent exposure of the wound to infectious agents e.g. bacteria present in the environment, but also to soak exudations and secretions from the wound. These bandages need to be removed at regular intervals. In poor hygienic or environmental conditions e.g. those frequently present in developing countries, the wounds cannot be managed adequately and remain exposed to dust and environmental infestations which can contribute to important infections of the wound. Despite efficacious anti-microbial treatment and improved supportive measures, wound treatment still poses immense challenges. Treatment and cure for invasive infections, blunt injuries, burns caused by electrical or chemical accidents, radiation burns and the like, is not very effective and leaves much to be desired.

According to the present invention a network as defined above is provided for external or topical application, for the treatment and cure of all types of wounds and lesions in humans and animals. The network exhibits remarkable efficacy in treating and curing wounds, possibly which are regarded as ‘incurable’ in state of the art.

The network as defined above improves blood flow, tissue growth and has immuno-modulatory properties. The network is also useful for treating infections and chronic non healing wounds like diabetic foot ulcer, dry and wet gangrene, venous ulcer, varicose veins, war wounds, burn wounds, post operative situation and the like.

Another embodiment of the invention is that the network acts by applying it topically e.g skin applications and or externally (gynaecological applications, mucous membranes etc).

The invention also relates to a medical device comprising a surface, the medical device comprising a structured network as defined above coated to the surface.

Advantageously, the invention relates to the medical device as defined above, said medical device being a wound dressing; a patch; a film; a wound filler; an hydrogel dressing; a skin substitute; an hydrocoilloid dressing or a foam. The invention relates to in vitro devices such as a carrier for cells, molecules, genes, bioactive compounds or nanoparticles; and an in vitro scaffold for organoid culture.

Medical devices according to the invention can be used for an implantation in human or animal body, but can also be used in vitro as a coating of culture dishes or a scaffold for organ equivalent, organoid and spheroid tridimensional cultures.

The invention also relates to a method for producing a structured network, preferably a structured 3-dimensional network, the method comprising:
mixing
   a first organic solvent, in particular water, comprising a polymer containing at least two free amino functional groups; and
   a second organic solvent comprising a compound containing comprising 2 aldehyde groups of formula I,

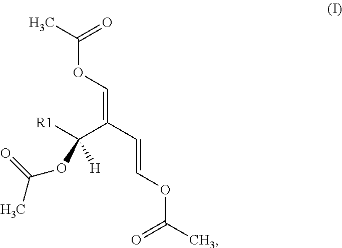

to obtain a mixture
wherein the stoichiometric ratio between the aldehyde functional group contained in the compound and the amino functional groups contained in the polymer is from 0.1 to 3,
wherein said first organic solvent is compatible, i.e. miscible, with said second solvent,
contacting the mixture with a basic composition or solution, to obtain a crosslinked mixture,
possibly washing the crosslinked mixture, and
recovering the crosslinked mixture which is in a form of a structured network, possibly 3-dimensional.

Advantageously, the invention relates to a method for producing a structured network, preferably a structured 3-dimensional network, the method comprising:
mixing
   a first organic solvent, in particular water, comprising a polymer containing at least two free amino functional groups; and
   a second organic solvent comprising a compound containing comprising caulerpenyne of formula III,

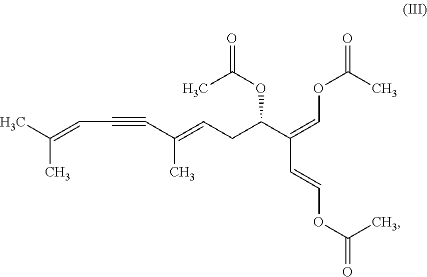 [SMILES: CC(=O)O/C=C(/C=C/OC(C)=O)[C@H](C/C=C(\C)C#CC=C(C)C)OC(C)=O]

to obtain a mixture
wherein the stoichiometric ratio between the aldehyde functional group contained in the caulerpenyne and the amino functional groups contained in the polymer is from 0.1 to 3,
wherein said first organic solvent is compatible, i.e. miscible, with said second solvent,
contacting the mixture with a basic composition or solution, to obtain a crosslinked mixture,
possibly washing the crosslinked mixture, and
recovering the crosslinked mixture which is in a form of a structured network.

In the above process, that allows to obtain the network as defined above, two steps are carried out:

STEP 1: Both polymer and compound as defined above are solubilized in an appropriated solvent, each in respectively in a first and a second solvent, compatible to each other. Then, since the compound harbor protected aldehyde groups by acetylation. Thus, the use of a basic composition or solution, preferably NaOH, will deprotect the aldehyde group of the compound. If the compound is caulerpenyne, the resulting compound after the basic composition treatment is the production of oxytoxine-2.

STEP 2: this step corresponds to the crosslinking per se. Free aldehydes of the compound with therefore react with the free amine contained in the polymer.

Depending upon the stoichiometric ratio, it is possible that some free compounds remain non crosslinked further to the reaction. It could be therefore advantageous to wash the network obtained. This is particularly important for an animal application of the resulting network, when the compound is caulerpenyne, since a toxicity of free caulerpenyne (CYN) has been reported (Parent-Massin (1996), Journal of Toxicology and Environmental Health, 47:1, 47-59).

Advantageously, the invention relates to the method as defined above, wherein the mixture is poured in a recipient and cooled down to a temperature from 2° C. to 15° C., preferably 4° C. and wherein the polymer containing at least two free amino functional groups is gelatin. Cool down is carried out during about 3h for jellification of gelatin. The basic composition is then added onto the gel of gelatin.

In view of the crosslinking reaction, it could be advantageous that the solution of polymer and compound be poured into a mold in order to give a predetermined form to the resulting network. Thus, prior to the addition of the basic solution, the mixture is poured on a mold chosen by the skilled person.

More advantageously, the invention relates to the method as defined above, wherein the mixture is contacted with the basic composition at 4° C. to 15° C. for 2 to 48h, preferably 24h.

The invention relates to a structured network, preferably a 3-dimensional structured network, obtained or liable to be obtained by the method as defined above.

The network is new and is characterized as defined above.

The invention also relates to a kit comprising:
a polymer containing at least two free amino functional groups as defined above; and
a compound of formula

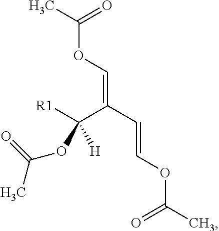

Wherein R1 is a C5-C25 alkyl, having one or more double bonds, and/or one or more triple bonds, possibly branched;
and possibly an aqueous basic solution.

The invention also relates to a compound:
of formula I as defined above, or
of formula II as defined above,
for crosslinking, preferably in vitro or ex vivo, a polymer containing at least two free amino functional groups, in order to obtain a structured network, possibly 3-dimensional, as defined above.

The invention also relates to the use of a compound:
of formula I as defined above, or
of formula II as defined above,
for crosslinking, preferably in vitro or ex vivo, a polymer containing at least two free amino functional groups, in order to obtain a structured network, possibly 3-dimensional.

The cross linker can be used after the 3D printing of gelatin or chitosan.

Already cross-linked gelatin droplets, such as organoids, can be introduced into the ink to be bioprinted.

### Examples

### EXAMPLE 1-Preparation of a Gel According to the Invention

In this example, it is disclosed a 3D structured network obtained from the crosslinking of gelatin and caulerpenyne.

STEP1: Gelatin (20% w/v) is solubilized in water at a temperature T=60° C. for 3 h.

Then, a mixture Caulerpenyne in ethanol (CYN/EtOH), was added to the solution to achieve the desired CYN concentration (with respect to gelatin). Subsequently, the formulation is poured in a silicon mould and cooled down to T=4° C. for 3h.

STEP2: The physical hydrogel containing CYN is then covalently crosslinked in a NaOH solution (0.1 M) for 24 h at T=4° C. To re-equilibrate the pH and remove any trace of non-reacted CYN the hydrogel was purified in water for 24 h at T=4° C.

### Example 2-Properties of the Network According to the Invention

Examples of gelatin hydrogels obtained with 5, 10, and 15% wt Caulerpenyne. Respectively, 0.053M, 0.107M, and 0.160M of Caulerpenyne solution is added in 2 mL of gelatin aqueous solution (Caulerpenyne. 20% w/v) Caulerpenyne. The abbreviated names for these samples are gel/CYN5, gel/CYN10, and gel/CYN15, respectively.

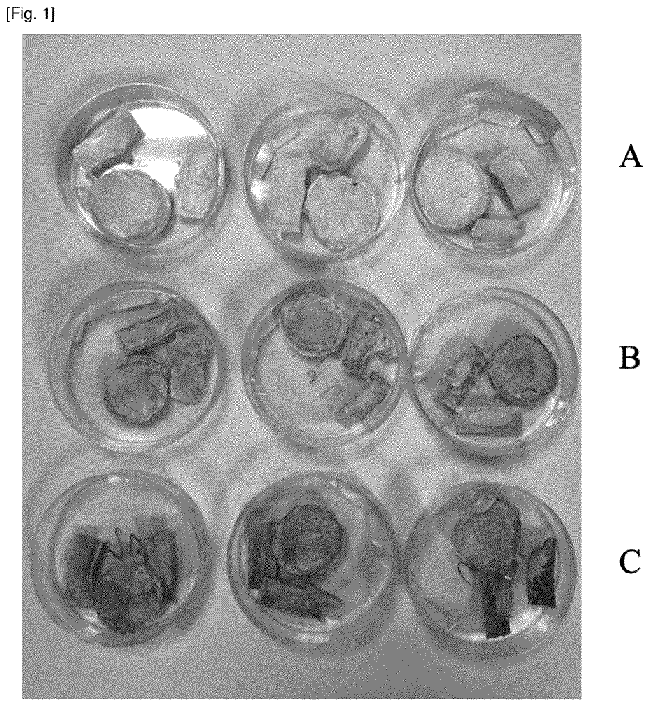

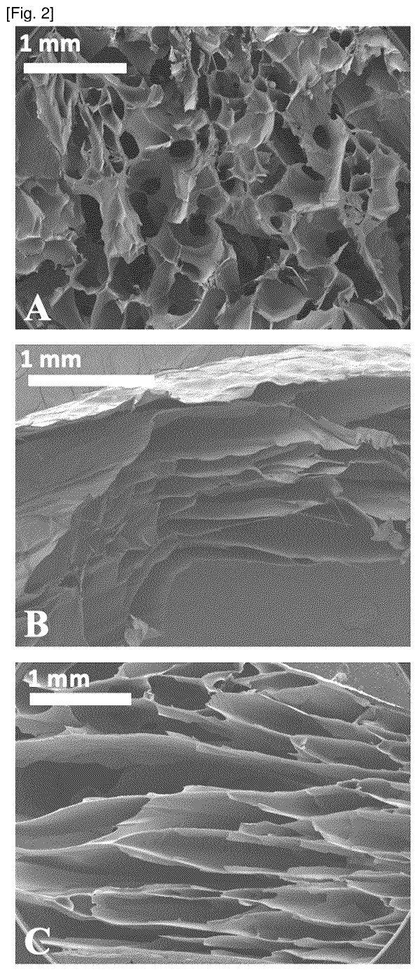

Macroscopic view are shown in FIG. 1.

Microscopic views of the networks are shown in FIG. 2. Larger porous have been observed for the gel/CYN crosslinked hydrogels compared (B, C) with the gelatin physical (un-crosslinked) (A) network.

The inventors also evaluated the stability of the networks obtained above.

The hydrolysis property of the crosslinked gel/CYN hydrogels was evaluated by immersing them in deionized water for a period of time. Degradation rates of the networks were then assessed. The swelling hydrogels were kept in water and placed in an incubator at 37° C. At the specified time points of 1,2 months, the remaining hydrogels were obtained, lyophilized, and weighed. The extent of biomaterial hydrolysis was determined by calculating the percentage of remaining weight compared with the original weight.

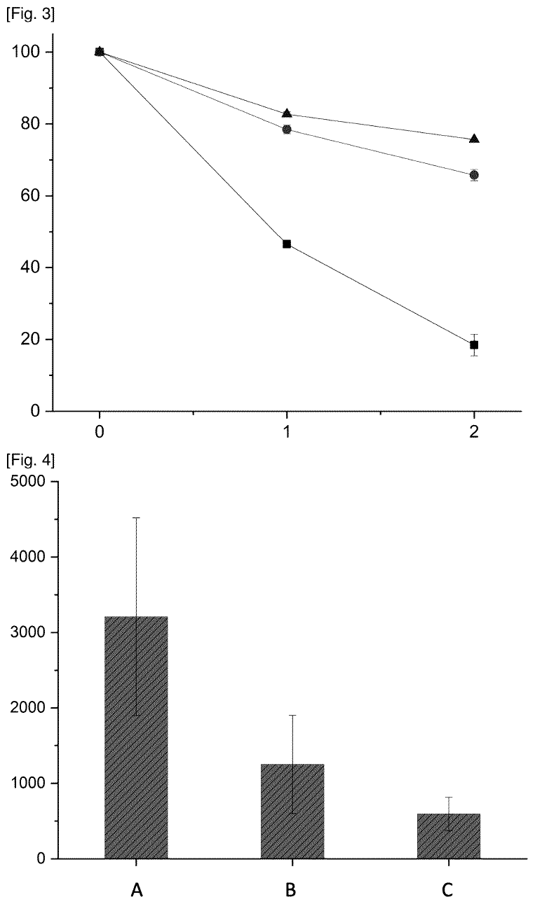

Results are shown in FIG. 3.

After two months of test, a drastic decrease of the weight for the gel/CYN 5% was observed. The weight loss observed after ageing at 37° C. is inversely proportional to the degree of crosslink.

The Inventors then evaluated the Swelling degree of the networks as described above. Swelling degree (SD) is a simple method to characterize the water adsorption and stability of the hydrogels. A highly cross-linked polymer shows less degree of swelling. Specimens with cylindrical shape (20 mm in diameter×10 mm thickness) were prepared and hydrated at 37° C. for 24 h. Subsequently, the samples were taken out from water medium, wiped with tissue paper to remove the excess of water, and weighted. The SD (%) was calculated by the following equation:

$$[ Math 1 ]$$

$$SD ( \% ) = \frac{{W}_{swollen} - {W}_{dry}}{{W}_{dry}} * 100$$

wherein W_{swollen} was the weight of the swollen sample after 24 h at 37° C., and W_{dry} the initial weight of the dry sample.

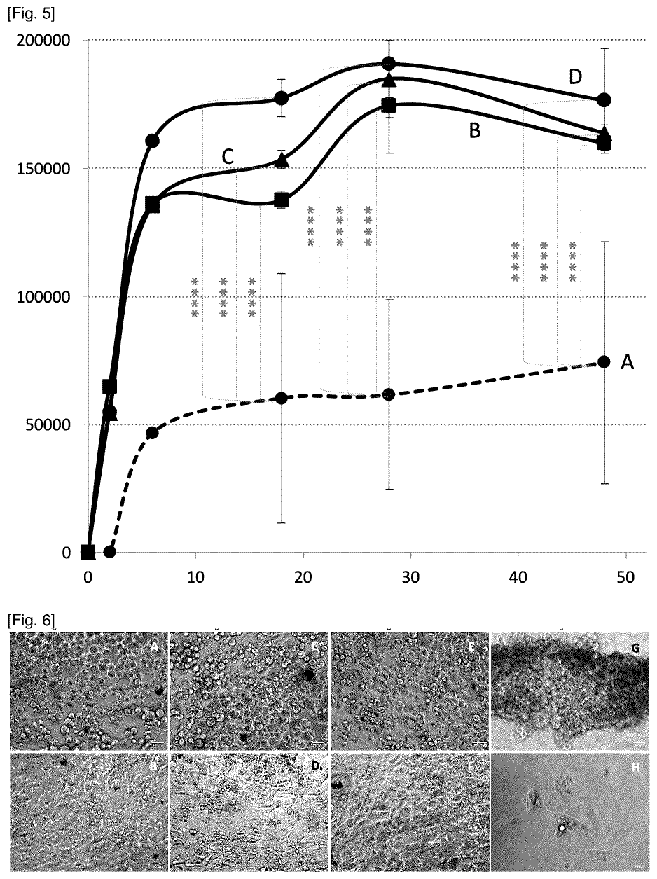

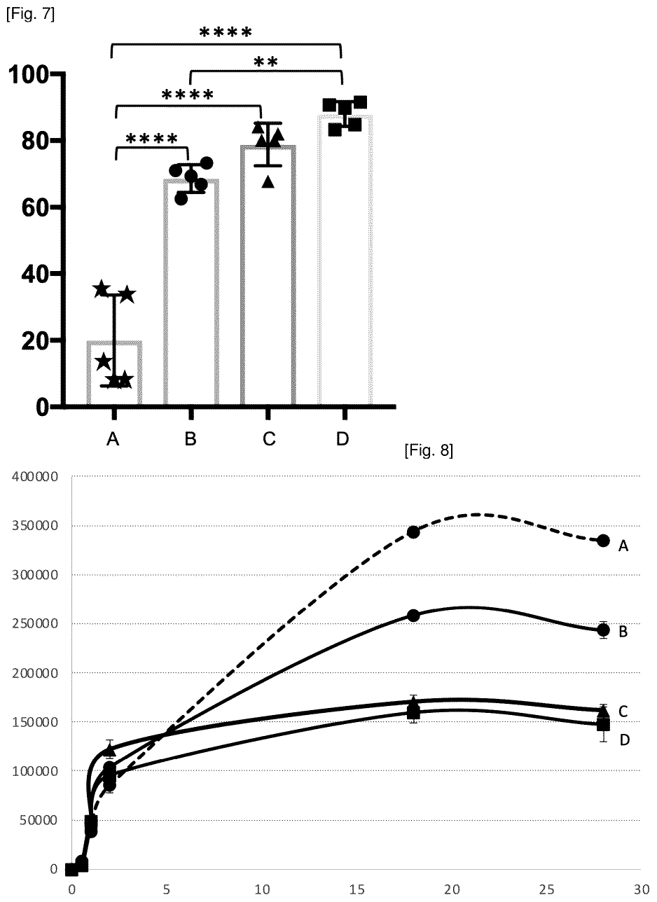

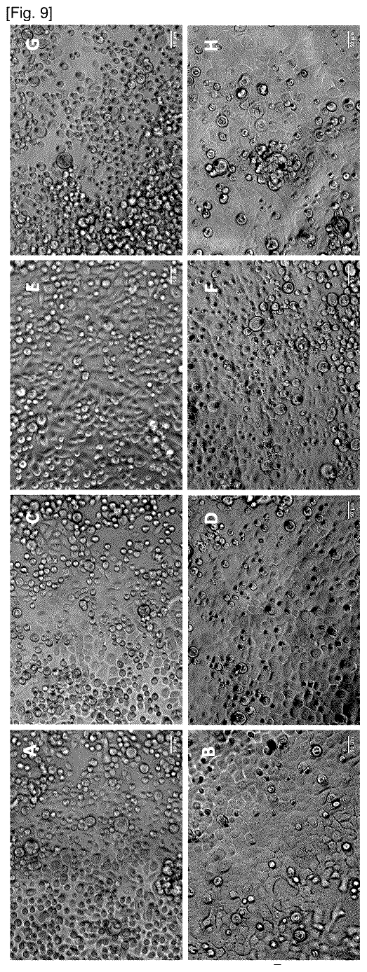

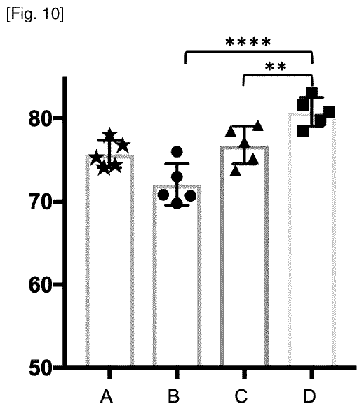

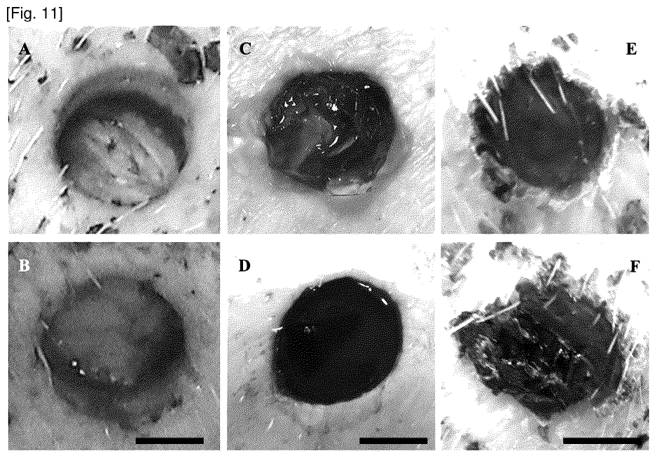

Results are shown in FIG. 4, and in Table 1.

TABLE 1

| Sample | Swelling degree (%) | Standard Deviation |
|---|---|---|
| Gel/CYN5% | 3209 | 1311 |
| Gel/CYN10% | 1248 | 653 |
| Gel/CYN15% | 593 | 224 |

Due to its poor hydrolytic resistance, within few minutes after immersion in water the un-crosslinked gelatin hydrogel was completely dissolved.

An increase of the caulerpenyne content leads to decrease the swelling degree. This behaviour demonstrates that a further addition of crosslinking agent (up to 15% w) increases the covalent linkages between gelatin chains thus decreasing the possibility for a solvent (here water) to swell on polymer chains.

### Example 3-Proliferation and Adhesion of Cells on the Network According to the Invention

In order to evaluate the properties of the network according to the invention on living cells, the inventors evaluated in vitro cell adhesion and growth as a model of dermis regeneration further to injury.

Normal human primary fibroblasts were isolated from human skin as previously described and maintained in culture in DMEM medium containing 10% FCS (fetal calf serum). Cells were detached from the culture plates and 10⁵ fibroblasts were seeded with 100 μl of DMEM 10% FCS (5 wells/condition) in a plate in which the bottom of the wells have been coated with
gelatin,
a reticulated network constituted by gelatin and caulerpenyne 5% wt/v,
a reticulated network constituted by gelatin and caulerpenyne 10% wt/v, or
a reticulated network constituted by gelatin and caulerpenyne 15% wt/v.

As control, wells coated with uncrosslinked gelatin were used.

The inventors first evaluated cell survival and growth over the time, further to the cell seeding onto the above-mentioned networks.

After 2 h at 37° C. in an humidified incubator at 5% CO₂, the cell culture medium was removed and replaced with DMEM 10% FCS containing 12,5% alamar Blue cell viability reagent. To monitor cell growth, absorbance of the well supernatants was recorded at 590 nm at different time points during 48h. Fibroblasts were photographed using an Axiovert 40 Zeiss microscope coupled to a Coolsnap Fx Camera (Roper Scientific, Evry, France). Unpaired t tests were used to analyze the data, with a p-value of less than 0.05 considered statistically significant. Statistical analyses were performed with GraphPad Prism software, version 8.4.2 (GraphPad Software). All results are expressed as the mean±SEM. **** p<0.0001 vs. control, Student's t-test.

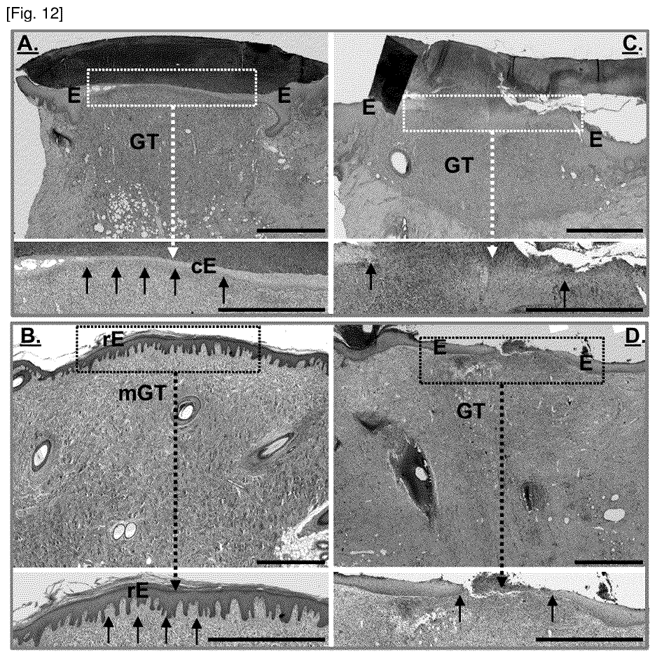

Results for cell proliferation, evaluated by Alamar Blue protocol, are shown in FIG. 5. These results show that cell growth over 48h is not affected when using the network according to the invention and that the gels allow regular growth to reach a living cell layer colonizing the gels. (FIG. 6) This is an advantage as dermal fibroblasts need to proliferate to be able to quickly colonize and fill the entire gel and then produce extracellular matrix to rebuild the dermis.

Then the inventors evaluated cell adhesion of fibroblasts onto the networks according to the invention. Human primary fibroblasts were detached from the culture plates and 4×10⁴ cells were seeded in each well in 100 μl of DMEM (5 wells/condition). After 1 h at 37° C. in an humidified incubator at 5% CO₂, the non-adhered cells were collected and counted. The number of adhered cells was deduced by subtracting the non-adhered cells from the total number of seeded cells. One-way ANOVA were used to analyze the data, with a p-value of less than 0.05 considered statistically significant. Statistical analyses were performed with GraphPad Prism software.

Results are shown on FIG. 7.

As expected, after 1 hour, percentage of adherent fibroblasts is the highest on plates coated with a network containing 15% w/v caulerpenyne. Moreover, whatever the concentration of caulerpenyne used, fibroblast adhesion is significantly increased compared to the non-reticulated gelatin (Gelatin)

These results show that the three cross-linked gels allow very rapid and effective adhesion of dermal fibroblasts, which is an advantage for the repair of skin wounds. They also show that the rigidity of the gel impacts this cell adhesion property because the more the gel is cross-linked, the faster the cells attach. This characteristic is an asset that can be exploited depending on the type of wound addressed.

In a second time, the inventors evaluated the properties of the network according to the invention on living cells, the inventors evaluated in vitro cell adhesion as a model of epidermis. Normal human primary keratinocytes were isolated from human skin and grown in culture in supplemented keratinocyte growth medium containing 0.15 mM CaCl₂ (KBM-2 BulletKit, Lonza Biosciences, Basel, Switzerland). Cells were detached from the culture plates and 4×10⁵ were seeded with 100 μl of KBM-2 medium in a plate in which the bottom of the wells have been coated with
gelatin,
a reticulated network constituted by gelatin and caulerpenyne 5% wt,
a reticulated network constituted by gelatin and caulerpenyne 10% wt, and
a reticulated network constituted by gelatin and caulerpenyne 15% wt.

The inventors first evaluated cell survival and growth over the time, further to the cell seeding onto the above-mentioned networks.

After 2H at 37° C. in an humidified incubator at 5% CO2, the cell culture medium was removed and replaced with KBM-2 containing 12,5% alamarBlue cell viability reagent. To monitor cell growth, absorbance of the well supernatants was recorded at 590 nm at different time points during 28h (until cells reached confluency). Keratinocytes were photographed using an Axiovert 40 Zeiss microscope. All results are expressed as the mean±SEM.

Results for cell viability, evaluated by Alamar Blue protocol, are shown in FIG. 8, and representative photos are shown in FIG. 9.

These results show that keratinocyte growth is compatible with the three cross-linked gels tested. The growth take place gradually and correctly on the surface of the three cross-linked gels to generate confluent cellular sheets resembling the epidermis. Uncrosslinked gelatin, known to be a good substrate for keratinocytes, induces cell hyperproliferation, generating at 24h, clusters of dead cells on the surface of the cell layer. It is noted that the more the gel is cross-linked, the more cell proliferation is controlled leading to a cohesive cell sheet. Being able to control the stiffness of the gel by modulating the cross link and thus modulating keratinocyte growth is a powerful feature. As epidermal regeneration is a resurfacing of the wound, keratinocyte to not enter within the gel but rather migrate and slowly disperse over it.

The cross-linked gels allow progressive development of the keratinocyte sheet without inducing the hyperproliferation seen with the uncrosslinked gelatin.

Then the inventors evaluated cell adhesion on keratinocytes onto the networks according to the invention.

Human primary keratinocytes were detached from the culture plates and 4×10⁴ cells were seeded in each well in 100 μl KBM-2 (5 wells/condition). After 1 h at 37° C. in an humidified incubator at 5% CO2, the non-adhered cells were collected and counted. The number of adhered cells was deduced by subtracting the non-adhered cells from the total number of seeded cells. One-way ANOVA were used to analyze the data, with a p-value of less than 0.05 considered statistically significant. Statistical analyses were performed with GraphPad Prism software.

Results are shown on FIG. 10.

The adhesion of keratinocytes to the three cross-linked gels is at least as good as on gelatin alone, known to be a good adhesion substrate for keratinocytes. Cell adhesion to the reticulated gels is progressive and correlated to the level of cross-link.

Thus, crosslinking of gelatin does not alter keratinocyte interaction with gelatin fibers. Therefore, the network according to the invention can be used as a support for keratinocyte (re) covering of a wound, with an efficiency similar to a natural epidermal regeneration process.

### Example 4-Synthesis of Compounds According to the Invention

The inventor's objective was to produce bio-sourced and valid alternative to CYN. CYN-like derivatives based on bio-sourced and commercially available platform molecules, such as citral and citronellal, to yield new crosslinking agents in sufficient amounts.

As previously reported on n-pentanal and 2-cyclohexylacetaldehyde model compounds a simple Horner-Wadsworth-Emmons (H.W.E.) reaction of citral (1) or citronellal (2) with phosphonoester (3) will afford an E/Z mixture of olefinic diesters. Subsequent separation of the two isomers, reduction of each with LiAlH4, and oxidation with Dess-Martin Periodinane (DMP) will yield CYN-like dialdehydes (1a), (1b), (2a), and (2b) as described in Scheme 1.

Pure compounds have been subjected to different spectroscopic techniques including NMR spectroscopy (1D, 1H, 13C, DEPT 135; 2D, 1H-1H COSY, 1H-13C HSQC, 1H-13C HMBC, 1H-1H ROESY/1H-1H NOESY) and HRMS spectrometry.

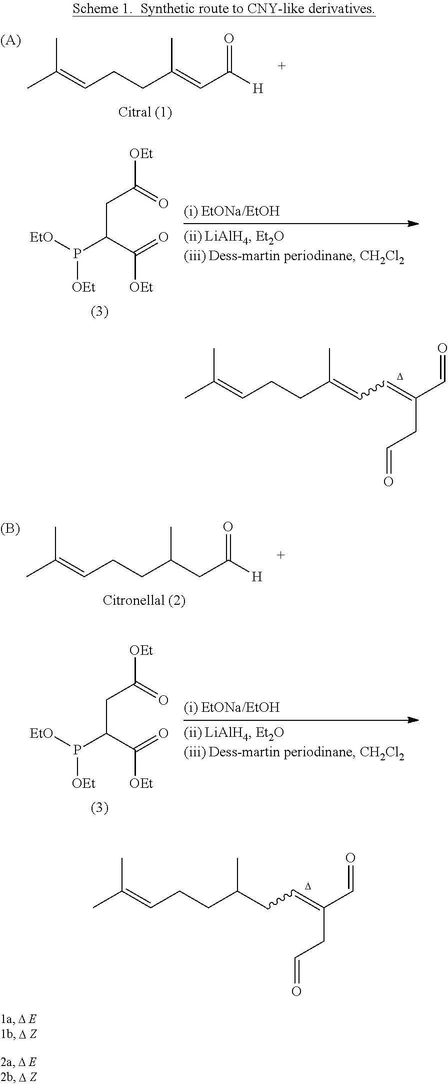

More generally, the compounds according to the invention of formula II, are obtained according to the following reaction

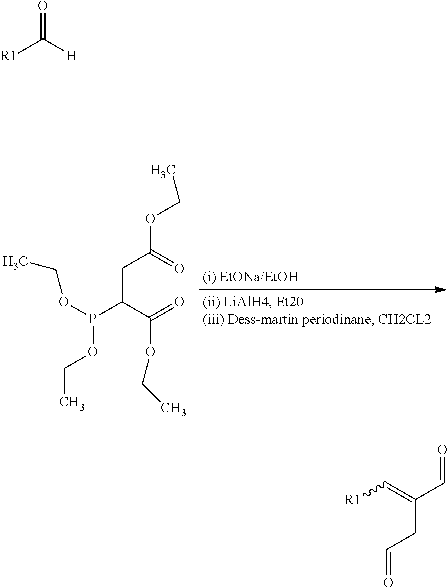

### Example 5-In Vivo Tests

In order to confirm that the network according to the invention can be safely and efficiently used in vivo, the inventors evaluated in pigs the skin repair by comparing the use of a gel according to the invention and a gel crosslinked with Genipin, a crosslinking agent of formula

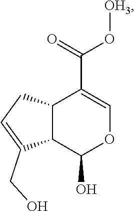

The healing promoting activity of a gelatin gel cross-linked at 5% with Caulerpeunyne (CYN) was evaluated in a porcine model of deep wound by comparing it with the same gelatin gel cross-linked at the same percentage with Genipin (GP), a commercial cross-linker of natural origin (FIG. 11). The two gels were equally easy to apply to the wounds, remained in place throughout the trial and showed no macroscopically significant differences in the healing process, which lasted until day 10.

Histological analysis of sections stained with HES from biopsies taken on the 7th and 10th day after injury showed significant differences in the healing process (FIG. 12). From the seventh day after treatment (D7, FIGS. 12A and C), wounds treated with the two gels show well-developed granulation tissue filling the entire wound space. However, the wounds treated with gelatin/CYN 5% were already completely re-epithelialised by a thin layer of epidermis, whereas the epidermisation of the wounds treated with gelatin/GP 5% only begun at the two adjacent edges of the wound (black arrows in the image representing the enlarged dotted frame). The analysis of the biopsies on day 10 shows very clear differences (FIGS. 12 B and D). The epidermis of the wounds treated with gelatin/CYN 5% was completely regenerated and reconstructed, whereas it had not completed the coverage of the granulation tissue in the wounds treated with gelatin/GP 5% (black arrows in the image representing the enlarged dotted frame). The maturation of the granulation tissue of wounds treated with the CYN 5% hygrogel was remarkably advanced and showed an appearance close to normal dermis when compared to the GP 5% counterpart, which was still in the inflammatory phase of the repair process. All these results show that Caleupenyne cross-linked gelatin is a hydrogel that can promote skin repair. Wounds treated with this hydrogel were already covered with an epidermis on the seventh day after injury and full healing was complete without any abnormalities on the tenth day.

The Caleupenyne cross-linked gelatin displayed a clear advantage over its genipin cross-linked counterpart, with which the wound re-epithelialisation was not complete on day 10 under the same conditions. The study of wound healing in a deep wound model in pigs shows that the cross-linking of gelatin by caleupenyne results in a material, whose biological and mechanical properties are extremely beneficial for the repair/regeneration process of skin wounds. Thus, this cross-linking agent confers exceptional skin-regenerating properties to the hydrogel obtained.

### Material and Method

Two full thickness wounds (punch biopsy 11 mm in diameter and 4 mm deep) were made on the backs of 2 female pigs. In each pig, one wound was treated with a gelatin hydrogel cross-linked with Caulerpenyne (CYN, 5% w/v) and a control wound was treated with a gelatin hydrogel cross-linked with Genipin (GP, 5% w/v). The gel-treated wounds were covered with a secondary dressing consisting of a microporous polyurethane film (Tegaderm), sterile dressings and Elastoplast to protect and secure them. The quality of each wound was clinically assessed at D7 and D10 after wound treatment using photographs, and a secondary dressing change was performed at D7. A biopsy including all wounds treated with the two gels from the same pig was performed at D7 and D10. The samples were immediately processed for microscopic examination. The experiments were performed at the Institut Claude Bourgelat VetAgro Sup Campus Vétérinaire de Lyon, where the pigs were kept under pathogen-free conditions in facilities approved by the Accreditation for the Care of Laboratory Animals and complying with the current regulations and standards of the French Ministry of Agriculture. All procedures used in this study were approved by the Institutional Animal Care and Use Committee of VetAgro Sup, Campus Vétérinaire de Lyon, France. For histological analysis, biopsies were processed for paraffin embedding, and paraffin sections were processed for haematoxylin-eosin-saffron staining (HES). The stained skin sections were scanned with a ZEISS Axioscan 7 and the images processed with Fiji software.

1-17. (canceled)

18. A composition consisting essentially of a homogenous mixture of:
a polymer containing at least two free amino functional groups, and
a compound comprising an aldehyde functional group, said compound being of formula I 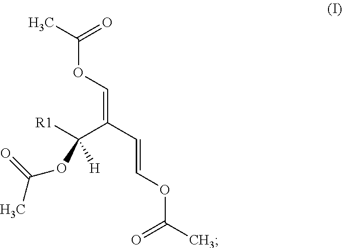
or of formula II, 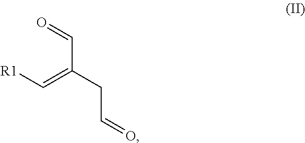
wherein R1 is C5-C25 alkyl, having one or more double bonds, and/or one or more triple bonds, possibly branched, and
wherein the stoichiometric ratio between the aldehyde functional group contained in the compound and the amino functional groups contained in the polymer is from 0.1 to 3.

19. The composition according to claim 18, wherein the compound represents from 5 to 15% by weight of the composition.

20. A structured network comprising or consisting essentially of a polymer containing at least two free amino functional groups operably crosslinked to compound comprising two aldehyde groups of formula II, 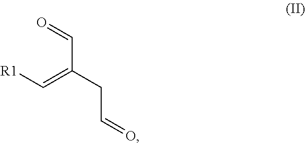
wherein R1 is C5-C25 alkyl, having one or more double bonds, and/or one or more triple bonds, possibly branched, and
wherein the stoichiometric ratio between the aldehyde functional group contained in the compound and the amino functional groups contained in the polymer is from 0.1 to 3,
or an hydrated form thereof.

21. The structured network according to claim 20, wherein the polymer containing at least two free amino functional groups is an animal or plant protein, a polysaccharide containing an amino group or an artificial amino polymer.

22. The structured network according to claim 21, wherein the animal or plant protein is chosen from gelatin, keratin, casein and lactoserum proteins, elastin, collagen, soy protein, serum bovine albumin, fibrin and fibrinogen, and resilin.

23. The structured network according to claim 20, wherein the compound of formula II is oxytoxin-2 of formula III

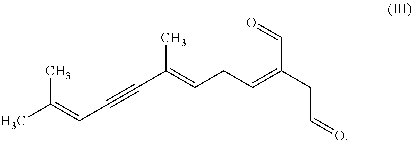 [SMILES: CC(C)=CC#C/C(C)=C/C/C=C(\C=O)CC=O]

24. The structured network according to claim 20, wherein the polymer containing at least two free amino functional groups is chosen from gelatin and chitosan.

25. The structured network according to claim 20, wherein the compound represents from 5 to 15% by weight of the structured network.

26. A method for lubricating a hydrophobic surface of a device, the method comprising applying either:
i) a composition on the surface, the composition consisting essentially of a homogenous mixture of:
a polymer containing at least two free amino functional groups, and
a compound comprising an aldehyde functional group, said compound being of formula I 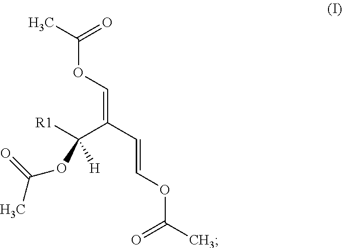
or of formula II, 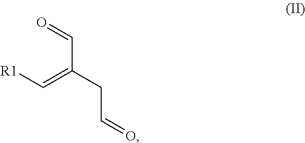
wherein R1 is C5-C25 alkyl, having one or more double bonds, and/or one or more triple bonds, possibly branched,
wherein the stoichiometric ratio between the aldehyde functional group contained in the compound and the amino functional groups contained in the polymer is from 0.1 to 3, or
ii) a structured network comprising or consisting essentially of a polymer containing at least two free amino functional groups operably crosslinked to compound comprising two aldehyde groups of formula II, 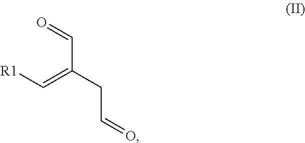
wherein R1 is C5-C25 alkyl, having one or more double bonds, and/or one or more triple bonds, possibly branched, and
wherein the stoichiometric ratio between the aldehyde functional group contained in the compound and the amino functional groups contained in the polymer is from 0.1 to 3,
or an hydrated form thereof

27. A method for treating an animal wound, the method comprising applying a structured network according to claim 20, onto a wound of the animal.

28. A medical device comprising a surface, the medical device comprising a structured network according to claim 20 coated to the surface.

29. The medical device according to claim 28, said medical device being a wound dressing; a patch; a film; a wound filler; an hydrogel dressing; a skin substitute; an hydrocoilloid dressing or a foam; a carrier for cells, molecules, genes, bioactive compounds or nanoparticles; and a scaffold for organoid culture.

30. A method for producing a structured network, the method comprising:
mixing:
a first organic solvent comprising a polymer containing at least two free amino functional groups; and
a second organic solvent comprising a compound containing comprising 2 aldehyde groups of formula I, 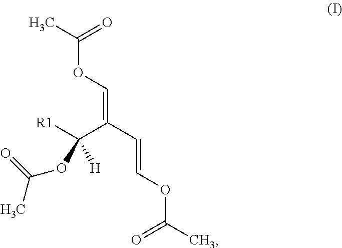
to obtain a mixture
wherein the stoichiometric ratio between the aldehyde functional group contained in
the compound and the amino functional groups contained in the polymer is from 0.1 to 3, wherein said first organic solvent is miscible in said second solvent,
contacting the mixture with a basic composition, to obtain a crosslinked mixture,
possibly washing the crosslinked mixture, and
recovering the crosslinked mixture which is in a form of a structured network.

31. The method for producing a structured network according to claim 30, wherein the mixture is poured in a recipient and cooled down to a temperature from 2° C. to 15° C., and wherein the polymer containing at least two free amino functional groups is gelatin.

32. A structured network obtained or liable obtained by the method according to claim 30.

33. A kit comprising:
a polymer containing at least two free amino functional groups as defined in claim 18, and
a compound of formula I 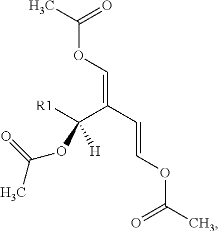
wherein R1 is a C5-C25 terpen;
and optionally an aqueous basic solution.

34. A method for crosslinking polymer containing at least two free amino functional groups, in order to obtain a structured network, the method comprising contacting the polymer with a compound as defined in claim 18, of formula I or of formula II.
